(19) United States
(12) Patent Application Publication
(10) Pub. No.: US 2003/0188036 A1
(43) Pub. Date: Oct. 2, 2003

(54) Methods and systems for program migration

(75) Inventors: Luojia Chen, Union City, CA (US); Timothy Mac, San Jose, CA (US)

Correspondence Address: John F. Nethery, SONNENSCHEIN NATH & ROSENTHAL, P.O. Box #061080, Wacker Drive Station, Sears Tower, Chicago, IL, 60606-1080, US

(73) Assignee: SUN MICROSYSTEMS, INC.

(21) Appl. No.: 10/171,306

(22) Filed: Jun. 12, 2002

Related U.S. Application Data
(60) Provisional application No. 60/366,831, filed on Mar. 22, 2002.

(51) Int. Cl. G06F 15/163; G06F 9/00

(52) U.S. Cl. 709/310; 709/328

(57) ABSTRACT

A migration program converts source files for a program developed for under a source server environment file-by-file to destination files compatible with a destination server environment. The migration program typically saves substantial developer time and resources that would otherwise be required to implement, test, and debug a program migrated manually to the destination server environment. Thus, programs may be made available to many more potential customers in a shorter period of time, for less cost.

### CROSS-REFERENCE TO RELATED APPLICATIONS

This application claims the benefit of, and incorporates by reference in its entirety, Provisional Application Serial No. 60/366,831 titled “Methods and Systems for Program Migration”, filed Mar. 22, 2002.

### FIELD OF THE INVENTION

This invention relates to providing compatibility for a pre-existing program (e.g., a word processor application) in a new data processing environment. In particular, the present invention relates to migrating a program from the server environment in which the program was originally developed to a new server environment.

### BACKGROUND OF THE INVENTION

A software developer typically writes a program under the assumption that the program will run in a particular server environment. The server environment includes, for example, the support and resources available to programs running in that server environment. As an example, the server environment may include a user-interface run-time library that implements windowing functions or a core library of Java routines.

Knowing the server environment, the developer may then incorporate features provided by that server environment into the program under development. Thus, for example, the developer may include in the program a call to the user-interface run-time library to open a window on a display.

In many instances, server environments provide a core set of common functionality regardless of the specific server environment or the machine on which the server environment runs. Thus, for example, most server environments that support the Java programming language implement a common core set of support libraries. For that reason, a Java program written for one server environment will often run without modification in a different server environment.

However, server environments commonly provide proprietary extensions to, for example, common core support libraries. A developer will often incorporate one or more of the proprietary extensions into the program under development in order to enhance the functionality of the program. There are few drawbacks in doing so, as the program remains targeted for execution in the server environment that supports the proprietary extensions.

In many instances, however, the developer needs to move the program to a new server environment. For example, the program may become quite popular, and marketing opportunities may therefore exist if the program could be sold to a wider audience than only those individuals running the original server environment for which the program was initially developed. Unfortunately, when the program incorporates proprietary extensions, or, more generally, any server environment specific support or functionality, it can be quite difficult to migrate the program to the destination server environment.

Migrating the program to the destination server environment requires a detailed knowledge of the incompatibilities between the source server environment and the destination server environment. It further requires a great deal of effort to resolve every incompatibility while still giving the program the functionality it was intended to have. Thus, a substantial investment in time, developer resources, and money may be required to migrate the program to the destination server environment.

Therefore, a need has long existed for a program migration tool that overcomes the problems noted above and others previously experienced.

### SUMMARY OF THE INVENTION

Methods and systems consistent with the present invention provide program migration from a source server environment to a destination server environment. The program migration typically saves substantial developer time and resources that would otherwise be required to support the program in the destination server environment. Thus, programs may be made available to many more potential customers in a shorter period of time, for less cost.

According to one aspect of the present invention, such methods and systems, as embodied and broadly described herein, include migrating a source project file-by-file to a destination project. For each file, the migration program determines incompatibilities in the file between the source server environment and the destination server environment. The migration program then makes appropriate substitutions (e.g., by replacing proprietary function calls) to render the file compatible with the destination server environment. Thus, the methods and systems eliminate significant developer time and attendant expense that would otherwise be necessary to migrate a program to the destination server environment.

Methods and systems consistent with the present invention overcome the shortcomings of the related art, for example, by maintaining a mapping database of proprietary extensions used in a source server environment with corresponding compatibility replacements for a destination server environment. Furthermore, the methods and systems provide conversion of deployment descriptor files from the source server environment to the destination server environment. Thus, developer time and resources are not unduly expended in an attempt to migrate a program manually.

In accordance with methods consistent with the present invention, a method is provided for migrating programs. The method migrates a source program written for a source server environment to a destination server environment. The method includes the steps of obtaining an input selection of at least one file of the source program, and, for each source file in the input selection, determining a file type for the source file and creating a corresponding destination program file compatible with the destination server environment based on the file type.

In accordance with systems consistent with the present invention, a data processing system is provided. The data processing system includes a memory comprising a program migration tool. The program migration program tool obtains an input selection of at least one file of a source program, and for each source file in the input selection, determines a file type for the source file, and creates a corresponding destination program file compatible with a destination server environment based on the file type. The data processing system further includes a processor that runs the migration program.

In accordance with articles of manufacture consistent with the present invention, a computer-readable medium is provided. The computer-readable medium contains instructions that cause a data processing system to perform a method for program migration of a source program written for a source server environment to a destination server environment. The method includes the steps of obtaining an input selection of at least one file of the source program, and, for each source file in the input selection, determining a file type for the source file; and creating a corresponding destination program file compatible with the destination server environment based on the file type.

Other apparatus, methods, features and advantages of the present invention will be or will become apparent to one with skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention.

FIG. 2 depicts a flow diagram showing processing performed by the program migration tool running in the memory of the data processing system of FIG. 1.

FIG. 3 depicts an exemplary deployment script created by the program migration tool running the memory of the data processing system of FIG. 1.

FIG. 4 depicts a flow diagram of the steps taken by the program migration tool running in the memory of the data processing system of FIG. 1 in order to provide compatibility in a destination server environment for proprietary extensions of a source server environment.

FIG. 5 depicts a flow diagram of the steps taken by the program migration tool running in the memory of the data processing system of FIG. 1 in order to provide compatibility in a destination server environment for deployment descriptor files from a source server environment.

FIG. 6 depicts an exemplary document type definition for migrating a deployment descriptor file from a source server environment to a destination server environment by the migration program 116 running in the memory of the data processing system of FIG. 1.

FIG. 7 depicts a data structure accessed by the migration program running in the data processing system shown in FIG. 1 that stores proprietary extension entries paired with corresponding compatibility replacements accessed by the migration program during creation of a destination program file that is compatible with a destination server environment.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

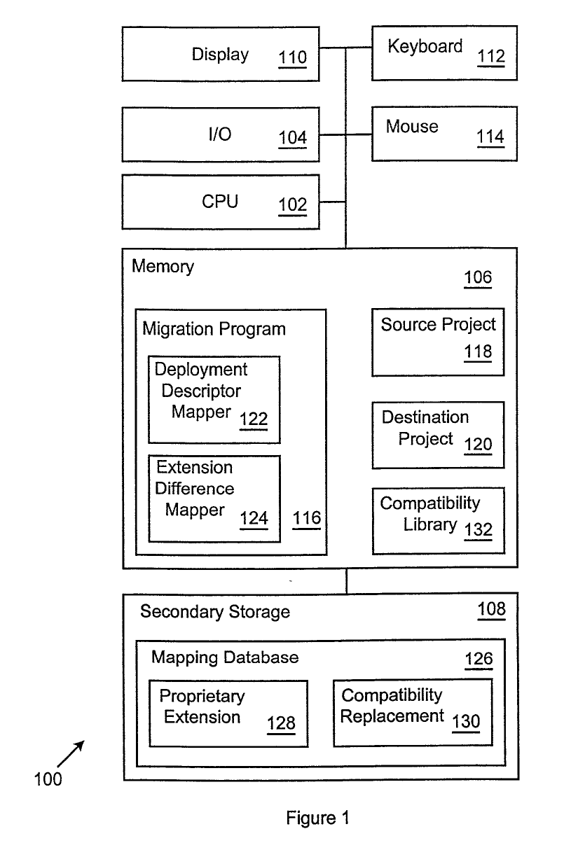

FIG. 1 depicts a block diagram of a data processing system 100 suitable for practicing methods and implementing systems consistent with the present invention. The data processing system 100 comprises a central processing unit (CPU) 102, an input/output I/O unit 104, a memory 106, a secondary storage device 108, and a video display 110. The data processing system 100 may further include input devices such as a keyboard 112 or a mouse 114.

The memory 106 contains a migration program 116 that operates on one or more files in a source project 118. The source project 118 comprises the files (e.g., source code files, configuration files, libraries, makefiles, deployment descriptors, and the like) that implement a program for a source server environment (e.g., the IBM Websphere Application Server). As an example, the source project 118 may implement an on-line bank application or other web based application.

The migration program 116 creates the destination project 120. The destination project 120 comprises the files that implement the program for the destination server environment (e.g., the Sun Microsystems iPlanet Application Server). To that end, the migration program 116 includes a deployment descriptor mapper 122 and an extension difference mapper 124 that will be described in more detail below. As an initial matter, however, it is noted that in the course of generating the destination program 120, the migration program 116 accesses the mapping database 126 to match a proprietary extension 128 (e.g., a call to a proprietary function in the source server environment) to a compatibility replacement 130 in the destination server environment.

The proprietary extension 128 is typically a call to a proprietary function, a Java Server Page (JSP) extension, or the like, supported by the source server environment. The compatibility replacement 130 is a mapping database 126 entry that specifies a function, extension, or the like that provides similar or identical functionality in the destination server environment. The compatibility library 132 stores the object, routines, and the like that provide compatibility as indicated by the mapping database 126.

Although aspects of the present invention are depicted as being stored in memory 106, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. Thus, for example, the mapping database 126 may be stored either in main memory 106 or on the secondary storage device 108. Further, although specific components of data processing system 100 are described, one skilled in the art will appreciate that a data processing system suitable for use with methods, systems, and articles of manufacture consistent with the present invention may contain additional or different components.

The overview provided below gives a summary of the steps taken by the migration program 116 for migrating a program from the IBM Websphere Application Server to the Sun Microsystems iPlanet Application Server running the Java 2 Enterprise Edition (J2EE) platform. The migration program 116 is not limited to any specific source or destination server or server software, however. Rather, the migration program 116 may generally be used to replace proprietary elements in a program with compatible replacements for a selected execution environment.

With regard to the IBM Websphere Application Server and the Sun Microsystems iPlanet Application Server, for example, incompatibilities can arise from proprietary Java API extensions, custom JSP tag extensions, application server specific deployment descriptors, and application server specific configuration parameters. As will be explained in more detail below, the migration program 116 initially accepts a selection of source project 118 files, or a selection of a directory containing the source project 118 files, as well as a selection for an output or destination directory. The migration program 116 then proceeds to migrate the source program 118 file-by-file to create the destination project 120 in the destination directory.

The types of files that the migration program 116 works with include, as examples, source files for Java application components, JSPs, servlets, Enterprise Java Beans (EJBs), Java helper files, Java application server deployment descriptors, eXstensible Markup Language (XML) deployment descriptors, application server configuration files, and the like. The migration program 116 may recognize the foregoing files, for example, according to their file extensions (e.g., .java, .jsp, .xml, .xmi). The migration program 116, for unsupported types of files, or files that do not need special processing (e.g., a file of text messages), may copy the file directly to the destination directory without modification. A migration report generated by the migration program 116 specifies which files were copied without modification, which files were migrated successfully, and which files were migrated unsuccessfully. In addition, the migration program 116 generates a deployment script that includes instructions for assembling the destination project 120 on the iPlanet Application Server.

The migration program 116 replaces proprietary extensions supported by the source server environment with compatible extensions supported by the destination server environment. In particular, the data processing system 100 provides the compatibility library 132 that includes functions specifically implemented for compatibility between the source and destination server environments. Furthermore, the migration program 116 maps custom JSP tag extensions supported by the source server environment to compatible tag extensions for the destination server. A further mapping converts XML deployment descriptor files (e.g., standard files such as ejb-jar.xml, weblogic-ejb-jar.xml, ibm-ejb-jar-bnd.cmi, and ibm-ejb-jar-ext.xmi) to corresponding destination server environment files (e.g., ias-ejb-jar.xml). Yet another mapping performed by the migration program 116 maps CMP deployment descriptor files with finder methods (e.g., in weblogic-cmp-rdbms-jar.xml) to corresponding XXX-ias-cmp.xml files (where XXX is the name of the EJB).

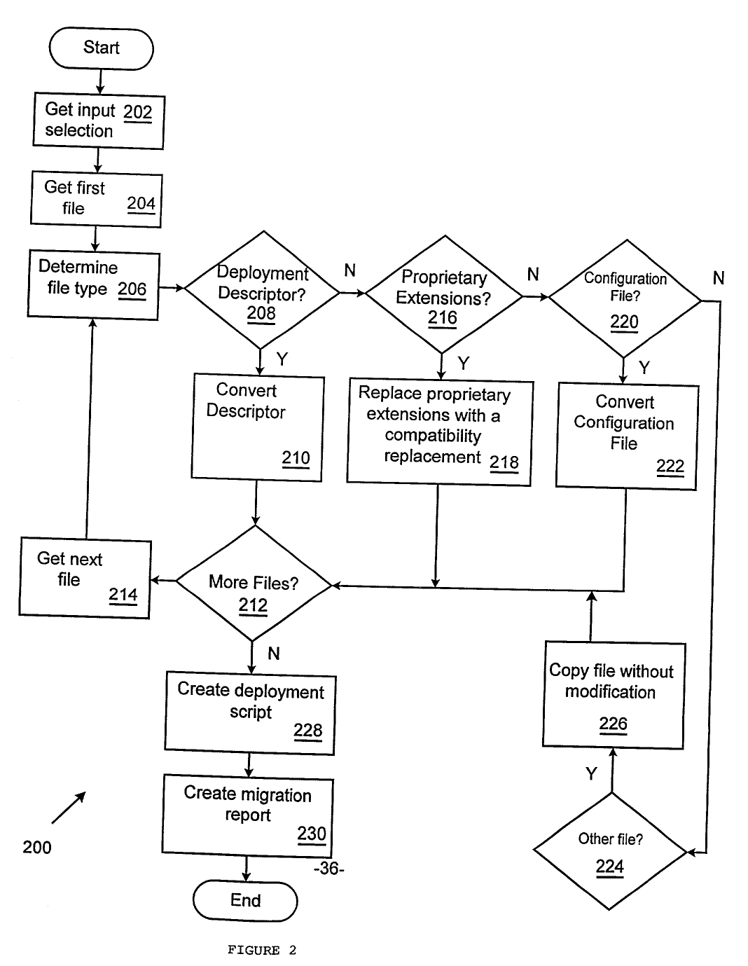

The operation of the migration tool 116 is described in more detail next, starting with FIG. 2.

Turning to FIG. 2, that figure depicts a flow diagram showing processing performed by the migration program 116 running in the memory of the data processing system of FIG. 1. The migration program 116 obtains an input selection for files in the source project 118 (step 202). The input selection may be, for example, a directory selection, or a specific selection of one or more files. When the input selection is a directory selection, the migration program 116 migrates files from the directory one-by-one into a selected output directory. The migration program 116 then retrieves the first file specified by the input selection (step 204).

Having retrieved the first file, the migration program 116 determines the type of the file, for example, by examining the file name extension or reading a portion of the file itself (step 206). For example, an html file may be identified by reading a line in the file that includes the <html> tag. Deployment descriptor files may be identified by a .xml or .xmi extension, for example, while extension files (e.g., source code and server page) files may be identified by a .java or .jsp extension.

The migration program 116 determines whether the file is a deployment descriptor file (step 208). If so, the migration program 116 converts the file into a format compatible with the destination server in a manner described in more detail below (step 210). The migration program 116 then determines whether there are more files to be migrated (step 212). If so, the migration tool obtains the next file (step 214) and continues at step 206.

Instead of a deployment descriptor file, the file may be one that possibly includes proprietary extensions. For example, the file may be a Java source code file with calls to proprietary functions, or a JSP file that uses proprietary tag extensions. The program migration tool determines if the current file is one that may include proprietary extensions (step 216). If so, the migration program 116 converts the file by replacing the proprietary extensions with a compatibility replacement in a manner described in more detail below (step 218). The migration program 116 then determines whether there are more files to be migrated (step 212).

The input file may be a configuration file (determined at step 220), for example “weblogic.properties” for the WebLogic Application Server 5.1. The migration program 116 recognizes the file names of configuration files and translates the configuration files for the destination application server (step 222) as described in more detail below.

When the input file is not any of the above types, or does not need any special processing (determined at step 224), the migration program 116 typically copies the input file (for example, a file of text messages or an .html file) without modification to the destination directory (step 226).

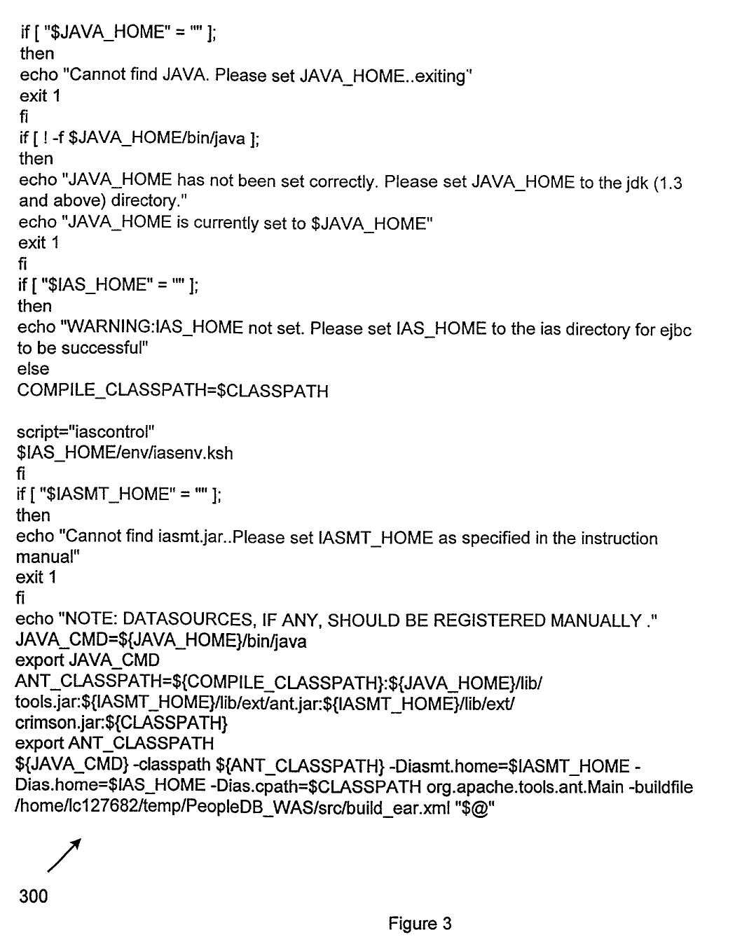

The migration program 116 also creates a script for the destination project 120 (step 228). In one embodiment, the script is a Unix shell script using Ant (which is a Java based tool that serves as an alternative to the Unix ‘make’ command). The script includes commands for compiling and assembling the destination project 120 in the destination server environment. An exemplary script is shown in FIG. 3.

After the migration program 116 has processed each file in the input selection, the migration program creates a migration report (step 230). The migration report may include, as examples, entries that specify which files migrated successfully, which files failed to migrate, and which files were copied without modification. With regard to a file that includes proprietary extensions, the file migrates successfully when each proprietary extension can be substituted for a compatibility replacement. With regard to deployment descriptor files, the file migrates successfully when (as described in more detail below) the file can be made consistent with the Document Type Definition (DTD) format of the destination server environment. Such files may not migrate successfully, as examples, when the source file is not well formed, does not conform to a source DTD format, or when the source file requires other files that cannot be found in the input selection. The migration report may also include a list of generated scripts.

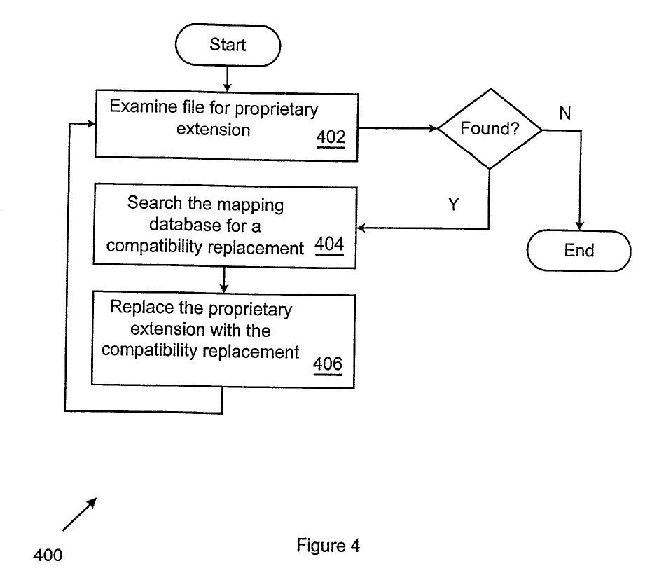

As noted above with regard to FIG. 2 and step 218, the migration program 116 (and in particular, the extension difference mapper 124 of the migration program 116) provide compatibility in a destination server environment for proprietary extensions of a source server environment. With regard next to FIG. 4, that figure depicts a flow diagram of the steps taken by the extension difference mapper 124.

The mapper 124 scans each input file for proprietary extensions (step 402). To that end, the mapper 124 compares statements in the input file against entries in the mapping database 126 to identify proprietary extensions. The mapping database 126 may be implemented, for example, as an XML file containing mapping pairs of proprietary extensions 128 and corresponding compatibility replacements 130. For example, an exemplary mapping pair for an API extension is shown below in Table 1.

TABLE 1

| Proprietary Extension Name | Compatibility Replacement Name |
|---|---|
| weblogic.db.jdbc.Column | sun.iasmt.compat.weblogic_5_1_0.weblogic.db.jdbc.Column |

An exemplary mapping pair for a JSP extension is shown below in Table 2:

TABLE 2

| Proprietary Extension Name | Compatibility Replacement Name |
|---|---|
| <wl:repeat> | wl/taglib.tld |
| | In taglib.tld, there is a mapping of the name |
| | “repeat” to the tagclass |
| | sun.iasmt.compat.weblogic_5_1_0.weblogic.jsp.Repeat |

The compatibility replacements 130 are functions, objects, tag extensions, and the like for the destination server that are created (prior to migration) and stored in the compatibility library 132. When the mapper 124 finds a proprietary extension, the mapper 124 then searches the mapping database 126 for a compatibility replacement (step 404). Next, the mapper 124 replaces the proprietary extension in the source file with the compatibility replacement 130 specified by the mapping database 126 (step 406). The mapper 124 continues until it finds no more proprietary extensions in the source file.

Referring again to FIG. 2, at step 210, the migration program 116 (and in particular the deployment descriptor mapper 122) migrates deployment descriptor files. In one embodiment, the mapper 122 uses Java Architecture for XML Binding (JAXB) to assist the migration process. JAXB provides an API and a tool that allow two-way mapping between XML documents and Java objects. With a given Document Type Definition (DTD), the JAXB compiler generates Java classes that allow developers to build applications that can read, manipulate and recreate XML documents without writing any logic to process XML elements. Typically, the source server environment and the destination server environment specify predetermined file names for required deployment descriptor files. For that reason, the mapper 122 typically generates specific files given the input files from the source server environment. An example of the deployment descriptor files for the WebLogic 5.1 server and WebSphere 4.0 server and their counterparts in the iPlanet server (iAS 6.5) is shown below in Table 3:

TABLE 3

| WebLogic 5.1 | iAS 6.5 |
|---|---|
| weblogic-ejb-jar.xml | ias-ejb-jar.xml |
| ejb-jar.xml | |
| weblogic-cmp-rdbms-jar.xml | <EJB_NAME>-ias-cmp.xml |
| ejb-jar.xml | |
| weblogic.xml | ias-web.xml |
| web.xml | |
| WebSphere 4.0 | iAS 6.5 |
| ejb-jar.xml | ias-ejb-jar.xml |
| ibm-ejb-jar-bnd.xmi | |
| ibm-ejb-jar-ext.xmi | |
| ejb-jar.xml | <EJB_NAME>-ias-cmp.xml |
| ibm-ejb-jar-bnd.xmi | |
| ibm-ejb-jar-ext.xmi | |
| server-cfg.xml | ias-web.xml |
| ibm-web-ext.xmi | |
| ibm-web-bnd.xmi | |
| web.xml | |

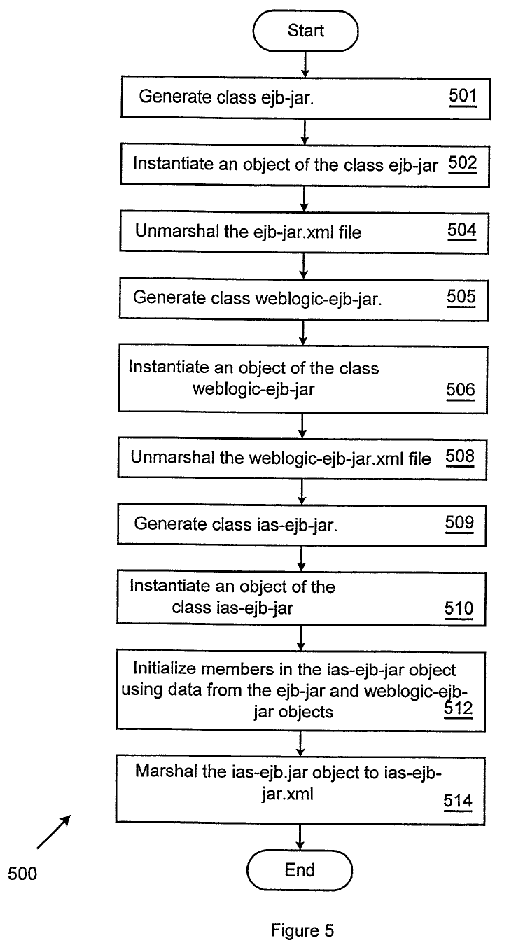

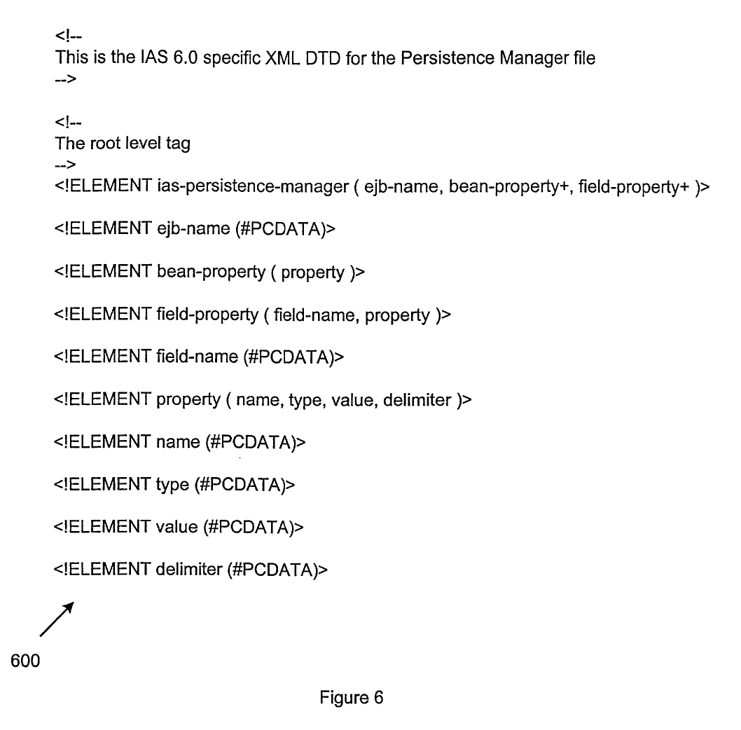

FIG. 5 depicts a flow diagram of the steps taken by the mapper 122 to migrate deployment descriptor files for the source destination server environment (in the example in FIG. 5, ejb-jar.xml and weblogic-ejb-jar.xml) to the deployment descriptor file for destination server environment file (ias-ejb-jar.xml). Note that for each XML file in Table 3, an appropriate DTD file for JAXB is available with the iPlanet Application Server installation in the <iAS_install>/ias/dtd/ directory. For example, “IASPersistence_manager_{—}1_{—}0.dtd” (shown in FIG. 6) provides a DTD specification for migrating the <EJB_NAME>-ias-cmp.xml file.

The mapper 122 first generates an ejb-jar class using the JAXB tool (step 501), then instantiates an object of the class ejb-jar (step 502). The mapper 122 then uses JAXB to unmarshal the ejb-jar.xml file (step 504). In other words, the mapper 122 populates the JAXB generated class object with data in the corresponding XML document. Similarly, the mapper 122 generates a weblogic-ejb-jar class using the JAXB tool (step 505), instantiates an object of the class weblogic-ejb-jar (step 506) and unmarshals the weblogic-ejb-jar file to populate the instantiated object (step 508).

Next, the mapper 122 generates an ias-ejb-jar class using the JAXB tool (step 509) and instantiates an object of the class ias-ejb-jar (step 510). Once instantiated, the mapper 122 then initializes members of the ias-ejb-jar object using data from the ejb-jar and weblogic-ejb-jar objects (step 512). In other words, the mapper 122 copies the data out of the objects corresponding to the source server environment deployment descriptor files into an object that is compatible with the destination server environment. The mapper 122 then marshals the ias-ejb.jar object to the ias-ejb-jar.xml file (step 514).

The marshalling process creates the .xml file with data from the Java object according to the DTD file defining the .xml file. In other words, the mapper 122, using JAXB generates a deployment descriptor file (ias-ejb-jar.xml) for the destination server environment based on the deployment descriptor files (ejb-jar.xml and weblogic-ejb-jar.xml) for the source server environment. Additional details of the operation of JAXB may be found, for example, at: http://developer.java.sun.com/.

The mapper 124 may also use the mapping database 126 when converting configuration files. When the mapper 124 encounters a proprietary extension in the configuration file, the mapper 124 retrieves a compatibility extension from the mapping database 126 and uses the compatibility extension in the output file. For example, the Weblogic 5.1 server uses a file named “weblogic.properties” that includes configuration information with regard to databases. The mapper 124 recognizes the introductory fixed syntax “weblogic.jdbc.connectionPool.ExampleApplication=” and a following database driver specification (e.g., “driver=oracle.jdbc.driver.OracleDriver”). The mapper 124 retrieves mapping information for the corresponding database from the mapping database 126 in order to generate the migrated file and may optionally create a script to register the database with the iPlanet Application Server. The source configuration file and an exemplary migrated file is shown below in Table 4:

TABLE 4
WebLogic 5.1 “weblogic.properties” file
weblogic.jdbc.connectionPool.ExampleApplication=\

url=jdbc:oracle:thin:@129.145.x.y:1521:orcl,\
driver=oracle.jdbc.driver.OracleDriver,\
initialCapacity=2,\
maxCapacity=8,\
capacityIncrement=1,\
allowShrinking=true,\
shrinkPeriodMins=15,\
refreshMinutes=10,\
props=user=tmb_user;password=tmb_user,\
testTable=CUSTOMER

iAS 6.5 “application.xml” migrated file
<ias-resource>
<resource>
<jndi-name>jdbc/ExampleApplication</jndi-name>
<jdbc>
<driver-type>oracle.jdbc.driver.OracleDriver</driver-type>
<database-url>jdbc:oracle:thin@10.100.a.b:1521:SUNLAB</database-url>
<username>tmb_user</username>
<password>tmb_user</password>
</jdbc>
</resource>
</ias-resource>

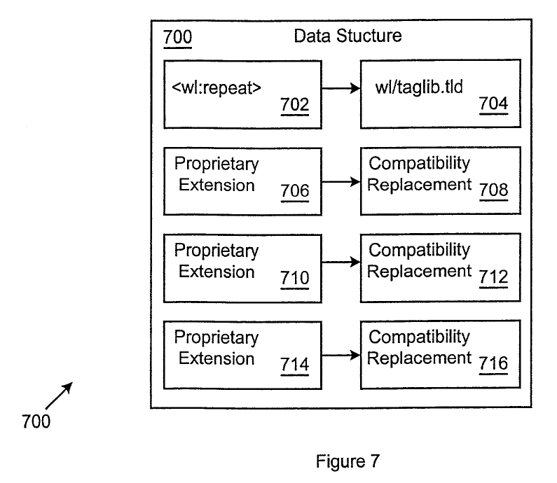

Turning briefly to FIG. 7, that figure illustrates a data structure 700 that stores the mapping pairs of proprietary extensions 702, 706, 710, 714 and corresponding compatibility replacements 704, 708, 712, 716. For example, FIG. 7 shows the <wl:repeat> tag mapped to the wl/taglib.tld file that provides a mapping to the tagclass specified above in Table 2. The mapping pairs may be, for example, entries in an XML text file.

The compatibility replacements 130 are functions, objects, tag extensions, and the like for the destination server that are created (prior to migration) and stored in the compatibility library 132. When the mapper 124 finds a proprietary extension, the mapper 124 then searches the mapping database 126 for a compatibility replacement (step 404). Next, the mapper 124 replaces the proprietary extension in the source file with the compatibility replacement 130 specified by the mapping database 126 (step 406). The mapper 124 continues until it finds no more proprietary extensions in the source file.

In one embodiment, the migration program 116 is designed in accordance with the Model-View-Controller (MVC) software architecture. The MVC architecture is described, for example, in Chapter 3 of Definitive Guide to Swing for Java 2, Second Edition, by John Zukowski, Apress 2000. Generally, the MVC architecture is an architecture for interactive programs that partitions the program so that it is scalable, maintainable, and re-usable. The Model section segments out underlying information (e.g., data structures) that the program manipulates. The View section provides the code that produces output on a display. The Controller section provides the code that handles user interaction and determines how to respond.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. The invention may be implemented with both object-oriented and non-object-oriented programming systems.

What is claimed is:

1. A method in a data processing system for migrating to a destination server environment a source program comprising source files written for a source server environment, the method comprising the steps of:
receiving an input selection of at least one source file for the source program; and
for each source file in the input selection,
determining a file type for the source file; and
creating a corresponding destination program file compatible with the destination server environment based on the file type.

2. The method of claim 1, wherein the step of determining comprises the step of determining between a plurality file types including an extension file type and a descriptor file type.

3. The method of claim 2, wherein the step of creating comprises the steps of:
when the file type indicates an extension file,
identifying a proprietary extension in the source file; and
replacing the proprietary extension with a compatibility replacement in the destination program file.

4. The method of claim 3, wherein the step of identifying comprises comparing a statement in the source file to entries in a mapping database, and further comprising the step of identifying the compatibility replacement in the mapping database.

5. The method of claim 3, wherein the step of replacing comprises replacing the proprietary extension with a compatibility replacement in a compatibility library provided by the destination server environment.

6. The method of claim 2, wherein the step of creating comprises the step of:
when the file type indicates a descriptor file,
determining a destination descriptor file name; and
converting the source file according to a selected document type definition file, wherein the destination program file is created with the destination descriptor file name.

7. The method of claim 2, wherein the step of determining comprises the step of determining a Java source code file to be an extension file type.

8. The method of claim 2, wherein the step of determining comprises the step of determining a Java server page file to be an extension file type.

9. The method of claim 2, wherein the step of determining comprises the step of determining an extensible markup language file to be a descriptor file type.

10. The method of claim 2, wherein the step of determining comprises the step of determining an extensible markup language metadata interchange file to be a descriptor file type.

11. The method of claim 1, further comprising the step of creating a migration report indicating which source files were successfully migrated.

12. The method of claim 1, wherein the destination server environment is the Sun Microsystems iPlanet Application Server environment.

13. A computer-readable medium containing instructions that cause a data processing system to perform a method for migration of a source program written for a source server environment to a destination server environment, the source program stored in the memory of the data processing system, the method comprising the steps of:
obtaining an input selection of at least one source file for the source program; and
for each source file in the input selection,
determining a file type for the source file; and
creating a corresponding destination program file compatible with the destination server environment based on the file type.

14. The computer-readable medium of claim 13, wherein the step of creating comprises the steps of:
when the file type indicates an extension file,
identifying a proprietary extension in the source file; and
replacing the proprietary extension with a compatibility replacement in the destination program file.

15. The computer-readable medium of claim 14, wherein the step of identifying comprises comparing a statement in the source file to entries in a mapping database, and further comprising the step of identifying the compatibility replacement in the mapping database.

16. The computer-readable medium of claim 14, wherein the steps of identifying comprise comparing the extension to entries in an extensible markup language file comprising the mapping database, and identifying the compatibility replacement in the extensible markup language file.

17. The computer-readable medium 13, wherein the step of creating comprises the step of:
when the file type indicates a descriptor file,
determining a destination descriptor file name; and
converting the source file according to a selected document type definition file; wherein
the destination program file is created with the destination descriptor file name.

18. The computer-readable medium of claim 13, wherein the step of creating comprises the step of copying the source file to the destination program file without processing.

19. The computer-readable medium of claim 13, wherein the destination server environment is the Sun Microsystems iPlanet Application Server environment.

20. A data processing system comprising:
a memory comprising a migration program for receiving an input selection of at least one file of a source program, and for each source file in the input selection, determining a file type for the source file, and creating a corresponding destination program file compatible with a destination server environment based on the file type;
a mapping database comprising mapping pairs of proprietary extensions to corresponding compatibility replacements; and
a processor that runs the migration program.

21. The data processing system of claim 20, wherein the input selection is a directory selection.

22. The data processing system of claim 20, wherein the input selection is file selection.

23. The data processing system of claim 20, wherein the mapping database is stored on a secondary storage device.

24. The data processing system of claim 23, wherein the mapping database comprises an extensible markup language file.

25. The data processing system of claim 23, wherein the migration program creates a deployment script in the memory, the deployment script comprising compilation commands for compiling the destination program file in the destination server environment.

26. The data processing system of claim 23, wherein the source file is a Java source code file.

27. The data processing system of claim 23, wherein the source file is a Java server page file.

28. The data processing system of claim 23, wherein the source file is an extensible markup language file.

29. The data processing system of claim 23, wherein the source file is an XML metadata interchange file.

30. The data processing system of claim 23, wherein the destination server environment is the Sun Microsystems iPlanet Application Server environment.

31. A computer-readable memory device encoded with a data structure created by a migration program that is encoded in the computer-readable memory device and that is run by a processor in a data processing system, the data structure comprising mapping entries, each mapping entry comprising:
a proprietary extension entry paired with a corresponding compatibility replacement, wherein the migration program accesses the data structure to select the corresponding compatibility replacement during creation of a destination program file that is compatible with a destination server environment.

32. The computer-readable memory device of claim 31, wherein each mapping entry is an extensible markup language mapping entry.

33. A data processing system comprising:
means for obtaining an input selection of at least one file of the source program; and
means for determining a file type for the source file; and
means for creating a corresponding destination program file compatible with the destination server environment based on the file type for each source file in the input selection.

34. A method in a data processing system for migration of a source program written for a source server environment to a destination server environment, the method comprising the steps of:
receiving an input directory selection of source program files;
obtaining a destination directory selection for storing destination program files;
for each source program file in the input selection to be converted to a destination program file,
determining a file type for the source file;
when the file type indicates a source program file that is compatible with the destination server environment, copying the source program file without modification to the destination directory as the destination program file;
when the file type indicates an extension file,
identifying a proprietary extension in the file; and
replacing the proprietary extension with a compatibility replacement in the destination program file created in the destination directory; and
when the file type indicates a descriptor file,
determining a destination descriptor file name; and
converting the source file to the destination program file according to a selected document type definition file, wherein the destination program file is created in the destination directory with the destination descriptor file name.

35. The method of claim 34, further comprising the step of creating a migration report comprising entries that indicate whether each of the source program files migrated successfully.

36. The method of claim 34, further comprising the step of creating a deployment script comprising compilation commands for compiling the destination program files in the destination server environment.

37. The method of claim 34, wherein the destination server environment is the Sun Microsystems iPlanet Application Server environment.
